(19) United States
(12) Patent Application Publication
(10) Pub. No.: US 2010/0302363 A1
(43) Pub. Date: Dec. 2, 2010

(54) Shade analysis device

(76) Inventor: Simon Andrew Mackenzie, Surrey (CA)

Correspondence Address: Willard S. MacDonald, 825 Olema-Bolinas Road, Bolinas, CA, 94924, US

(21) Appl. No.: 12/802,231

(22) Filed: Jun. 2, 2010

Related U.S. Application Data
(60) Provisional application No. 61/183,495, filed on Jun. 2, 2009.
(60) Provisional application No. 61/187,045, filed on Jun. 15, 2009.
(60) Provisional application No. 61/254,645, filed on Oct. 23, 2009.

(51) Int. Cl. H04N 7/18; H04M 1/00; G06F 19/00

(52) U.S. Cl. 348/135; 455/556.1; 702/5; 348/E07.085

(57) ABSTRACT

A shade analysis device includes an accelerometer providing samples that represent an elevation defined by a sighting reference, an electronic compass providing samples that represent an azimuth heading defined by the sighting reference, and a processor under the control of a program included in the shade analysis device, acquiring an array of the samples that represent an azimuth heading and an array of corresponding samples that represent the elevation, in response to tracing with the sighting reference, a skyline at an interface between an open sky and at least one solar obstruction over a range of azimuth headings.

### CROSS-REFERENCE TO RELATED APPLICATIONS

Pursuant to 35 U.S.C. section 119(e)(1), this application for patent claims priority to the filing dates of U.S. Provisional Patent Application Ser. No. 61/183,495 filed 2 Jun. 2009, U.S. Provisional Patent Application Ser. No. 61/187,045 filed 15 Jun. 2009, and U.S. Provisional Patent Application Ser. No. 61/254,645 filed 23 Oct. 2009, all of which are herein incorporated by reference.

### BACKGROUND OF THE INVENTION

The present invention is in the technical field of shade analysis. More particularly, the present invention is in the technical field of tools for the analysis of the sunlight and solar energy that can be captured at a particular geographic location.

Shade analysis includes determining the impact of trees, buildings or other solar obstructions on the amount of sunlight that falls on a given geographic location. Shade analysis typically involves acquiring the profile of the skyline, which is the interface between the open sky and obstructions that block the sun, and determining the position of the sun in the sky relative to the given location versus time and day of the year. With this information it is possible to determine when the location will be shaded by the solar obstructions. From this, statistics such as annual shade factor or other suitable measures of shade analysis may be established.

Existing methods for shade analysis use azimuth and elevation sights of the skyline that are taken using surveying instruments, these sights are then hand drawn on “sun plots” (paper charts that shows the path of the sun at a given latitude), or the sights are manually entered into a computer system where the effect of the solar obstructions can be determined.

Another method of shade analysis uses a device with a fish-eye dome lens that is placed on a level platform and oriented south using a compass. This fish-eye dome lens projects a 360 degree image of the horizon onto the platform, which enables the skyline to be projected and traced onto a paper sun plot chart. The information from the skyline on the sun plot charts can be manually input into a computer program that produces statistics on the amount of solar energy at the location. However, the devices used in this method are bulky and the method is time consuming and error prone.

Enhancements to the above-disclosed method of shade analysis have been made through the use of digital cameras that are held directly over the fish-eye dome lens to acquire a digital image of the horizon. The acquired digital images are downloaded to a separate computer where the pixel data in the digital images are analyzed to extract the skyline. This method has the drawback of requiring the manual configuration of three separate pieces of equipment, which is time consuming. In addition, this equipment is typically bulky and not suitable for rooftop analysis, and depending on the light conditions in which the digital images are acquired, manual editing of the images may be required to get accurate results.

Another method of shade analysis uses a digital camera to capture a series of digital images of the horizon that are referenced to a known compass orientation, and taken at fixed, known tilt angles. The digital images of the horizon are captured and downloaded to a separate computer where software “stitches” the individual images into a panoramic digital image. The pixel data on the panoramic digital image is then analyzed to determine the skyline. However, this method requires that the camera be held at a precise and consistent tilt angle when capturing the digital images, which typically involves using a special tripod attachment. Further, a user that implements this method of shade analysis must ensure that there is overlap between all of the captured images.

Yet another method of shade analysis relies on capturing a digital image of the skyline directly through a digital camera that has a fish-eye lens. Here, the digital camera is held level with the fish-eye lens pointing directly up to the sky, while an azimuth reference for the digital camera is oriented south using a compass. The fish-eye lens projects a 360 degree image onto the digital camera's light sensitive array, which captures the digital image of the sky. The digital image is then analyzed by an internal processor or it is downloaded to an external computer for pixel analysis to determine the skyline. While this method typically provides for highly accurate shade analysis, the method typically relies on a custom fish-eye lens and extensive factory calibration of the fish-eye lens, compass and a level, which may result in a high manufacturing cost.

### SUMMARY OF THE INVENTION

Embodiments of the present invention include an integrated, portable shade analysis device that enables a user to trace the skyline at a given location. Once the skyline is traced, the shade analysis device computes statistics on the light and solar energy that is received at the location. These statistics typically include hours of sunlight, shade factor, available solar energy, optimum position for solar panels, revenue generated from a specified solar installation, or any other suitable measure of shade analysis that represents any of a variety of solar effects at the location. These statistics may be displayed in graphical and/or tabular form for any chosen time period, or the statistics may include a graphic showing an animated sun moving across the skyline over the course of a day, or a plot of hours lost to shading each day of the year due to solar obstructions.

The shade analysis device enables a user to edit the traced skyline to simulate the removal of a solar obstruction, and then re-runs the statistics with the solar obstruction removed. While the shade analysis device is capable of computing the statistics, performing analysis and presenting results, the user-traced skyline or any other data or results are optionally exported to another computer system or device for presentation or further analysis, typically via a wired or wireless communication interface that may be included in the shade analysis device.

Using commonly available astronomical formulas, the shade analysis device calculates the position of the sun relative to the location of the shade analysis device at any given time. By comparing the information on the sun's position with the skyline, the invention performs shade analysis. The effect of a solar obstruction, such as a tree, may result in a significant difference in sunlight at two locations that are only a few feet apart. For example, at one location sunlight may be obstructed only over a very limited time interval, while at another location, just a few meters away, sunlight may be obstructed for the entire month or more. Due to the quick tracing of the skyline and the speed of subsequent processing provided by the shade analysis device, shade analysis may be quickly performed at a number of locations to find the optimum location, for example, to maximize the amount of direct sunlight.

The shade analysis device typically includes a GPS receiver to determine the location of the shade analysis device, an accelerometer for determining elevation or tilt angle, and an electronic compass for determining azimuth heading. The shade analysis device may also include a digital camera and an associated display. The shade analysis device typically includes a program that is implemented as a software application that runs on a smart phone, gaming system, computer, or other portable electronic device. These devices are suitably equipped with sufficient processing resources, memory, and displays to enable an included program to integrate the measurement, computational, and display functions.

According to first embodiments of the present invention, the program included in the shade analysis device enables a user to trace the skyline using a measurement edge of the shade analysis device as a sighting reference. As the skyline is traced with the measurement edge, the shade analysis device stores samples of the elevation and azimuth heading provided by the accelerometer and electronic compass, respectively, in a memory. The program filters or otherwise processes the samples of the elevations and azimuth headings to establish the skyline that is presented to the shade analysis device at the given location.

According to second embodiments of the present invention, the shade analysis device provides a cross-hair on the display for sighting the skyline. Here, the user aims the cross-hairs at the skyline and varies the elevation of the device so as to trace, with the cross-hairs, the skyline presented to the device over a range of azimuth headings. As the user traces the skyline by moving the shade analysis device, the elevations of the sighted points on the skyline at each increment of azimuth heading are stored in the memory.

According to third embodiments of the present invention, the user pans the horizon with the digital camera while capturing images. As the horizon is panned, the program monitors the azimuth heading and automatically captures the images that include the skyline at azimuth headings that are sufficiently small to ensure overlap between the captured images. The elevations and azimuth headings associated with the images are recorded and stored in memory. The captured images may be “photo stitched” together, using commonly available tools. This enables the azimuth heading and elevation at any point on the captured images to be derived from the azimuth heading and elevation corresponding to any of one or more of the captured images.

### BRIEF DESCRIPTION OF THE DRAWINGS

The present invention can be better understood with reference to the following Figures. The components in the Figures are not necessarily to scale. Emphasis is instead placed upon illustrating the principles and elements of the present invention.

FIGS. 1A, 1B show schematics of typical components of a shade analysis device according to embodiments of the present invention.

FIG. 2 shows a perspective view of the shade analysis device included in a housing.

FIG. 3 shows alternative views of the shade analysis device relative to reference directions.

FIG. 4 shows an example wherein the shade analysis device is oriented at an elevation.

FIG. 5 shows an example of a user orienting the shade analysis device to obtain the elevation of a sighting-point on a solar obstruction.

FIG. 6 shows an alternative example wherein the shade analysis device is used with a sighting apparatus to obtain the elevation of a sighting point on a solar obstruction.

FIG. 7 shows a perspective view of an example horizon presented to the shade analysis device at a location.

FIG. 8 shows an example of a plan view of the location shown in FIG. 7.

FIG. 9 shows an example of a sun plot for the location shown in FIG. 7.

FIG. 10 shows a perspective view of a user tracing the skyline that includes the solar obstructions.

FIG. 11 shows an example format of arrays including elevations and azimuth headings for the user-traced skyline.

FIG. 12 shows an example of the user-traced skyline superimposed on the sun plot and provided on the display of the shade analysis device.

FIG. 13 shows an example of a “what-if” scenario, to determine the impact of removing a solar obstruction from the user-traced skyline.

FIG. 14 shows an example of the skyline traced through sequential sighting of positions on the skyline.

FIG. 15 shows a side view of the shade analysis device further including a digital camera.

FIG. 16 shows a plan view of the shade analysis device corresponding to the side view of FIG. 15.

FIG. 17 shows an example of cross-hairs presented on the display of the digital camera, providing a sighting reference for user-tracing of the skyline.

FIG. 18 shows a perspective view of a sweep of the skyline detected via the acquisition of multiple images.

FIG. 19 shows an example combination of multiple images used to detect the skyline.

FIG. 20 shows an example of an image acquired by the digital camera with overlaid grid lines indicating azimuth headings and elevations.

### DETAILED DESCRIPTION OF THE INVENTION

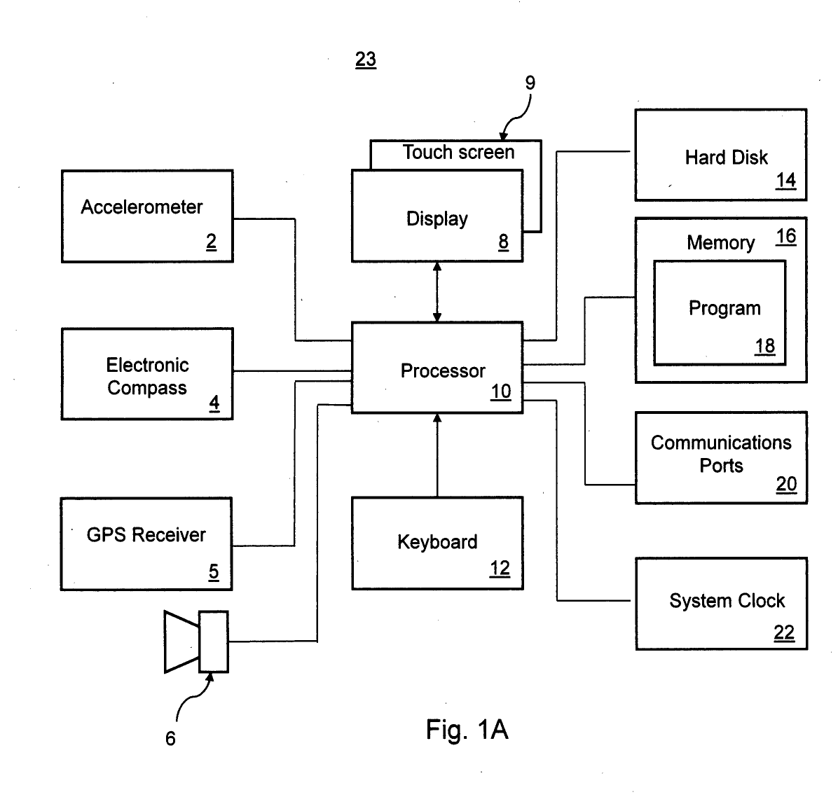

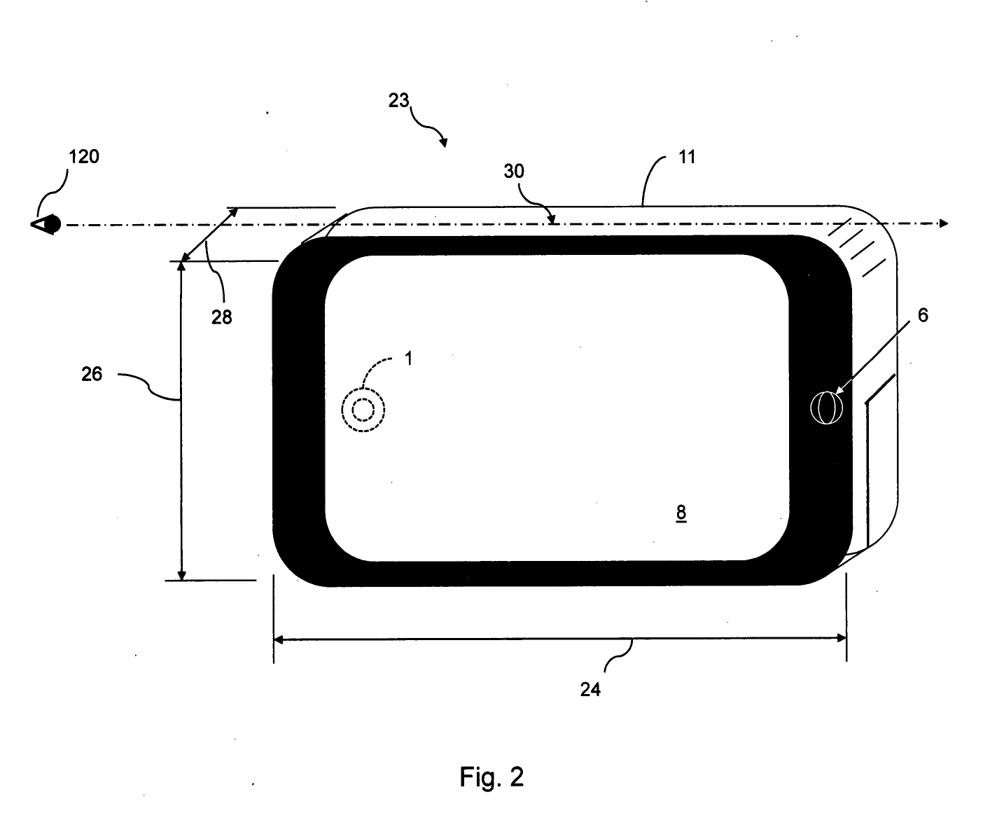

FIGS. 1A, 1B show schematics of typical components of a shade analysis device 23 according to embodiments of the present invention. The shade analysis device 23 includes an accelerometer 2 or other device suitable to measure the elevation, or tilt angle, of the shade analysis device 23 in the orthogonal reference directions X, Y, Z (shown in FIG. 3). The accelerometer 2 typically has an accuracy of one degree and typically provides samples representing the elevation, or tilt angle, at a sample update rate of 100 times per second. A processor 10 performs data collection and manipulation, and has an associated memory 16 that is sufficient to store a program 18 while being executed, and to store results. The memory 16 may include a hard disk 14, flash memory or other solid-state memory, and/or other form of non-volatile memory for storing the program 18 and user settings, or for archiving acquired samples or results for future use. The shade analysis device 23 has an associated display 8, with a typical resolution of 400 pixels by 200 pixels: The shade analysis device 23 typically includes a keyboard 12 and/or touch screen 9, or other type of user interface to enable entry of information. In an example where the shade analysis device 23 is implemented using an iPHONE, smartphone, computer, or other portable electronic device, the display 8 and the keyboard 12, touch screen 9 or other user interface may be integrated in a single screen. The shade analysis device 23 also may include a Wi-Fi, Bluetooth, USB, Ethernet or other type of communication ports 20 and a system clock 22 suitable for providing typical time interval resolutions of one millisecond, and for providing the date and time. An electronic compass 4 or other means of determining azimuth heading provides samples that represent the azimuth heading of the shade analysis device 23. The shade analysis device 23 may also include a speaker or other type of sound generating device 6 and a GPS receiver 5 for determining the location L of the shade analysis device 23. In FIG. 1B, the shade analysis device 23 further includes a digital camera 1, and the display 8 additionally serves as a view-finder for the digital camera 1.

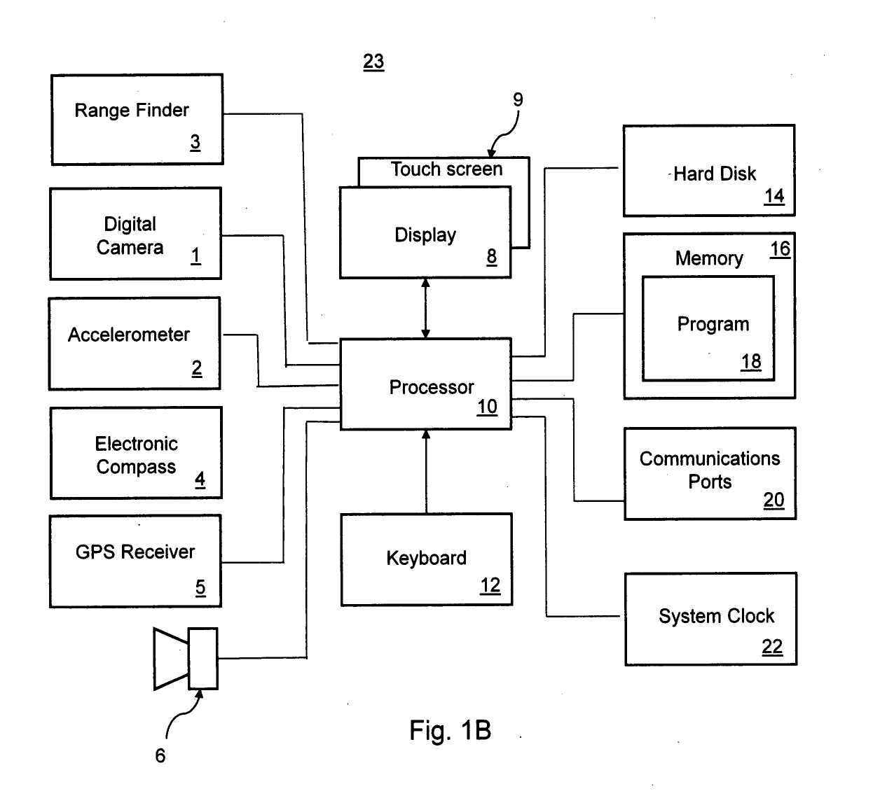

FIG. 2 shows a perspective view of the physical attributes of the shade analysis device 23 included in a housing 11. The housing 11 typically has a length 24, width 28, and height 26 of dimensions that enable the housing 11 to be held comfortably in a hand of a user of the shade analysis device 23. The housing 11 includes a sighting reference, which in this example is a measurement edge 30 that is straight and free from raised buttons or other features or elements that may block the line of sight from the eye 120 of a user along the measurement edge 30. In alternative examples, the measurement edge may be a feature of the shade analysis device 23 that enables the user to align the shade analysis device 23 along a vector from the user's eye to the skyline. In the shade analysis device 23 of FIG. 1A, the electronic compass 4 is configured physically and programmatically to provide a representation of an azimuth heading that is referenced to the measurement edge 30 and that is provided to the memory 16 associated with the program 18. In the shade analysis device 23 of FIG. 1B, the digital camera 1 is included on a face of the housing 11 that is opposite that of the display 8.

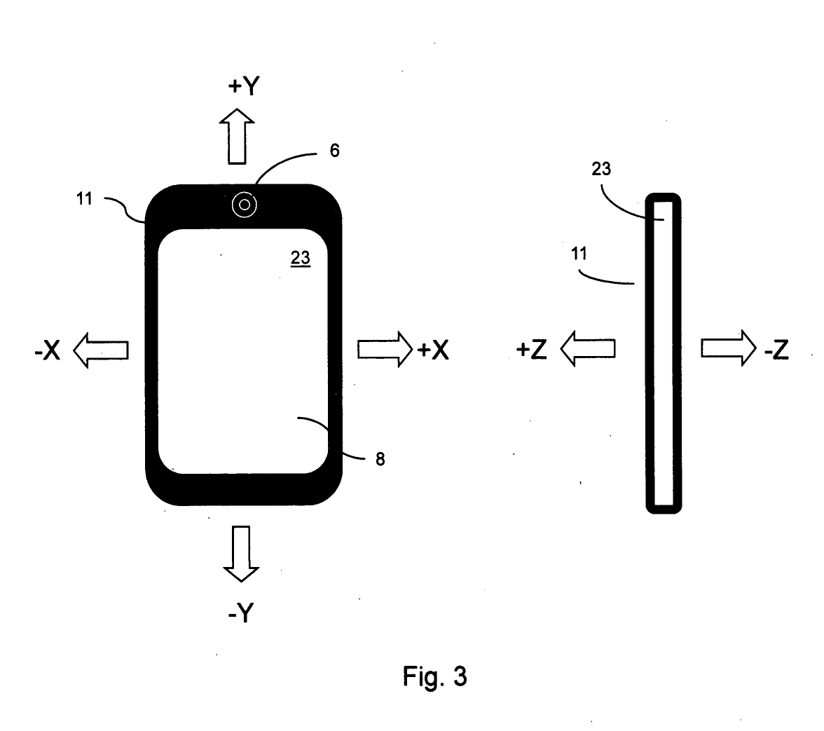

FIG. 3 shows example orientations of the housing 11 of the shade analysis device 23 relative to the orthogonal reference directions X, Y and Z. In this example, the top of the device, defined by the location of the sound generating device 6, is referenced to the direction Y. The accelerometer 2 measures forces due to movement (acceleration) and forces due to the Earth's gravity vector 46 (shown in FIG. 4). The forces due to movement are typically estimated as insignificant relative to the force due to the Earth's gravity vector 46 during use of the shade analysis device 23. The force of Earth's gravity vector 46 relative to each of the reference directions X, Y, Z may be used to determine the tilt angle, or elevation E, of the shade analysis device 23 as the orientation of the shade analysis device 23 is varied. In the orientation of the shade analysis device 23 illustrated in FIG. 3, the accelerometer 2 would provide a representation of elevation wherein the reference directions have values X=0, Y=1 g and Z=0. The program 18 includes a calibration procedure for the compass 4 and the accelerometer 2, consistent with the process recommended by the device manufacturer of the smartphone or other portable electronic device within which the shade analysis device is implemented.

In FIG. 4 the shade analysis device 23 is oriented at an elevation E of 45 degrees, typically measured relative to a horizontal plane (not shown) that is orthogonal to the direction of the Earth's gravity vector 46. Under ideal conditions, this orientation of the shade analysis device 23 would result in the accelerometer 2 providing a representation of elevation wherein the reference directions have values: X=0.5 g, Y=0.5 g and Z=0. Under these ideal conditions the reference directions X and Y are sufficient to determine the elevation E. However in practice, when the shade analysis device 23 is held in the hand of a user, the shade analysis device 23 may be held at a slight twist or misalignment in the direction Z, which may result in distorted readings in the directions X and Y. Accordingly, determining the elevation E of the shade analysis device 23 typically involves negating the misalignment in the direction Z by calculating the elevation E using the ATAN2 function in the C programming language, which is a two-argument variation of the arctangent trigonometry function. For any real arguments of the directions X and Y not both equal to zero, ATAN2(Y, X) provides the angle between the positive direction X and a plane containing the point having the coordinates (X, Y).

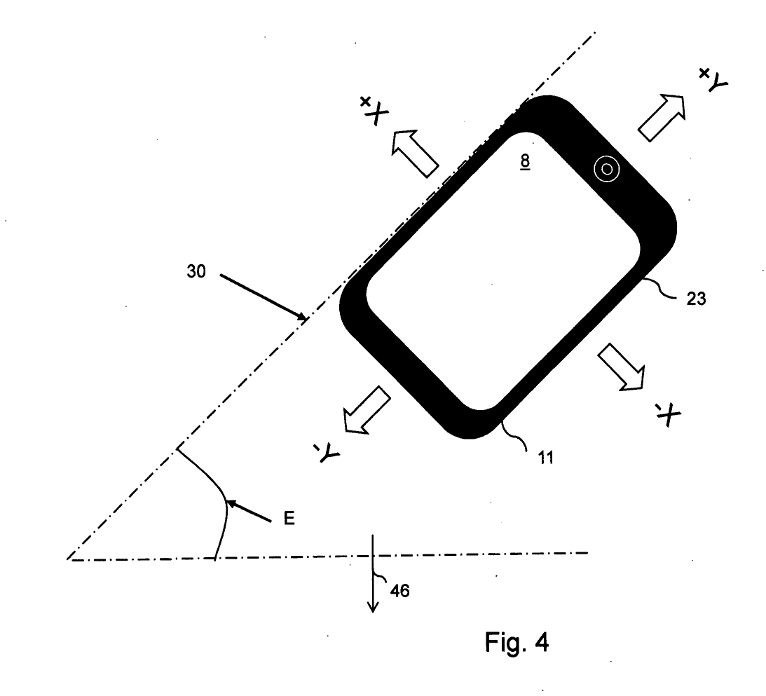

FIG. 5 shows an example of a user orienting the shade analysis device 23 to obtain the elevation E of a solar obstruction 122. For accurate measurement, the user of the shade analysis device 23 establishes a straight line of sight from the eye 120, along the measurement edge 30 to the solar obstruction 122. The measurement edge 30 enables the user to aim, or “sight” a skyline position 112 on the solar obstruction 122. The skyline position 112 is located at the interface between the solar obstruction 122 and the open sky. Sighting the skyline position 112 with the measurement edge 30 enables the accelerometer 2 to acquire the elevation E of the skyline position 112 at the location L of the shade analysis device 23. At the elevation E, with this sighting of the skyline position 112, the electronic compass 4 provides a corresponding representation of the azimuth heading H of the skyline position 112.

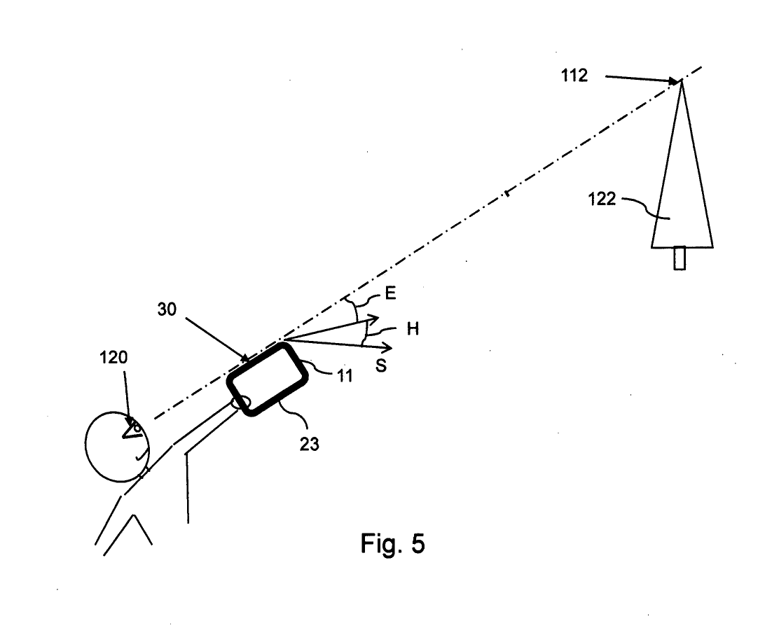

FIG. 6 shows an alternative example wherein the shade analysis device 23 is used with a sighting apparatus 74 to obtain the elevation E of the skyline position 112. This set-up may be used to improve accuracy in sighting the skyline position 112 by establishing a straight line of sight from the eye 120 of the user along the rear site 66 and foresight 64 to the skyline position 112 on the solar obstruction 122. In alternative examples, the skyline position 112 is sighted using a tripod and/or a telescopic sighting mechanism (not shown).

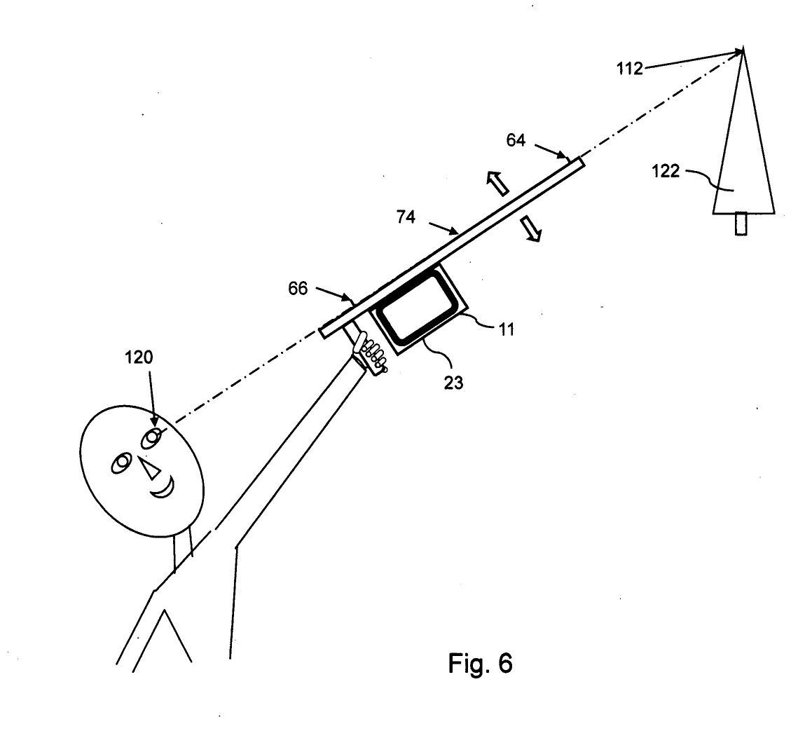

FIG. 7 shows a perspective view of a horizon presented to the shade analysis device 23. In this example, the horizon includes various solar obstructions such as a tree 122, a tree 126, a building 124 and a building 128 that influence the amount of sunlight and solar energy at the location L. An arrow S indicates an azimuth heading in the direction of south.

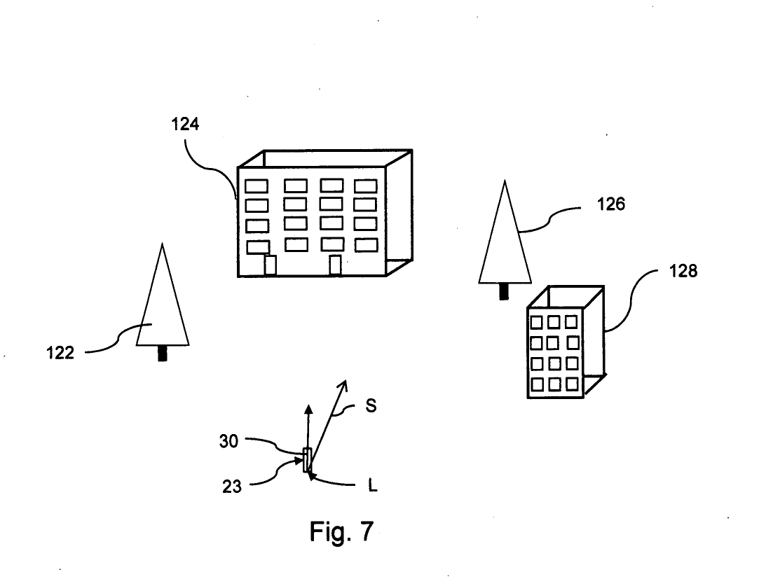

FIG. 8 shows an example of a plan view of the location L in FIG. 7, wherein the shade analysis device 23 is used to determine the effect of the tree 122, the tree 126, the building 124, and the building 128 on the sunlight and solar energy provided to the location L. In this example, the line 121 marks the beginning edge of the tree 122 and the line 123 marks the ending edge of the building 128.

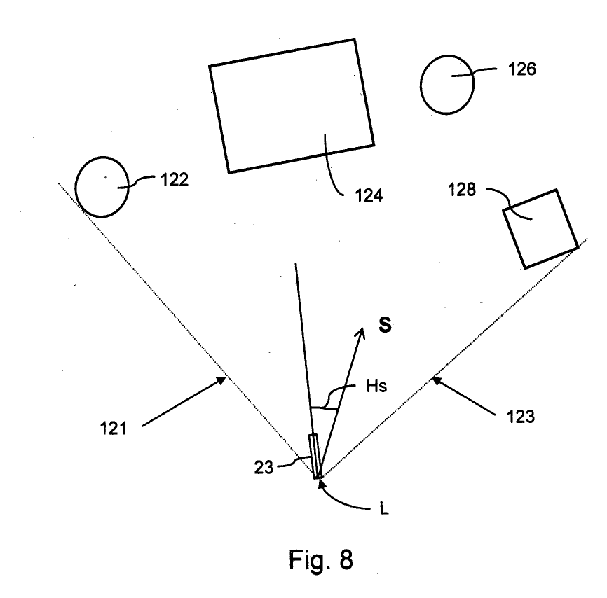

FIG. 9 shows a sun plot 32 for the location L where the shade analysis device 23 is used. In this example the GPS receiver 5 or other suitable means automatically determines location information, such as the latitude, longitude and height above sea level of the location L. Alternatively, the user of the shade analysis device 23 inputs the location information for the location L to the program 18 via the touchscreen 9, keyboard 12 or other user interface. The system clock 22 provides the current date and time. Using presently available astronomical formulas, the program 18 uses the location information, time and date to calculate the paths of the sun for the current day 144, the current position of the sun, represented by the sun icon 130, the path of the sun at the summer solstice (longest day) 146 and the path of the sun on the winter solstice (shortest day) 142. These paths are shown in the sun plot 32 on the display 8 in graphical format, with the horizontal axis scale indicating the azimuth heading H in degrees and with the vertical axis indicating elevation E in degrees. In one example, the current position of the sun 130 is updated every second, so that the sun icon 130 is displayed at the current elevation Es and azimuth heading Hs of the sun.

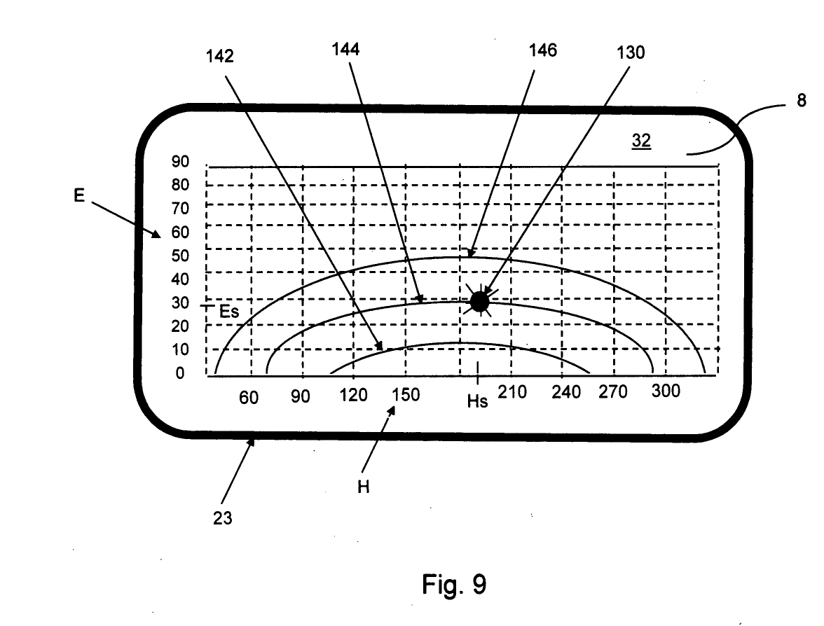

User-tracing of the skyline at the location L includes defining a range of azimuth headings which in this example is defined by the line 121 and the line 123 (shown in FIG. 10). The range of azimuth headings may be narrower or wider than the range defined by the solar obstructions 122-128 that are shown. The program 18, via input from the keyboard 12, touchscreen 9 or other user interface prompts a user to begin a sweep, or user-tracing, of the skyline 112x. At the start of the sweep, the user of the shade analysis device 23 orients the measurement edge 30 at the initial azimuth heading and sights an initial elevation on the skyline, which in this example is depicted by the point 130. The shade analysis device 23 then indicates to the user, typically with an audible signal from a sound generator 6, to begin tracing the skyline 112x by moving the shade analysis device 23 in the direction of the arrows on the skyline 112x to vary the azimuth heading H and the elevation E of the measurement edge 30 of the shade analysis device 23. In one example, the program 18 reads these azimuth headings from the electronic compass 4 and the program 18 automatically compensates for local magnetic deviation at the location L by using a deviation database derived from commonly available charts of magnetic deviation.

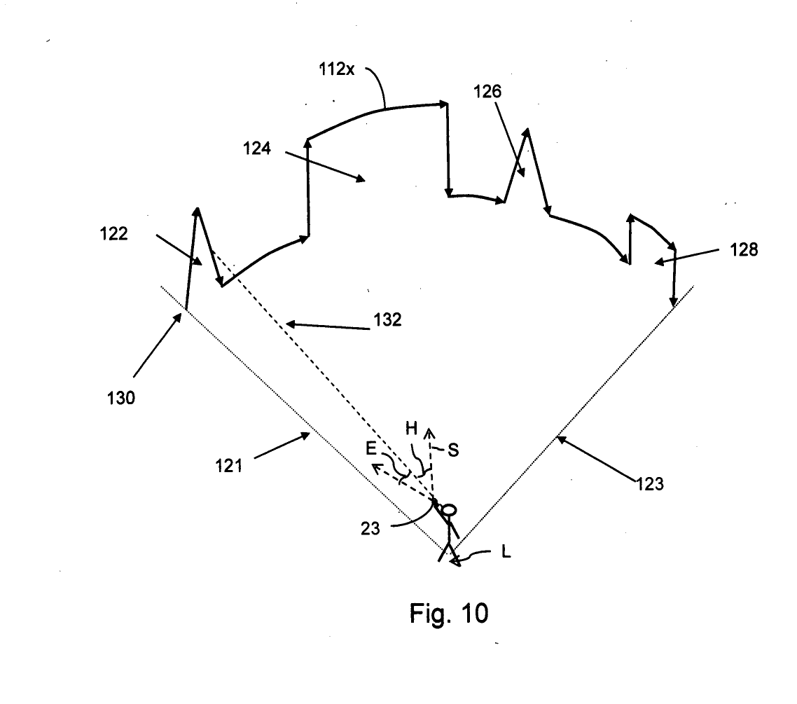

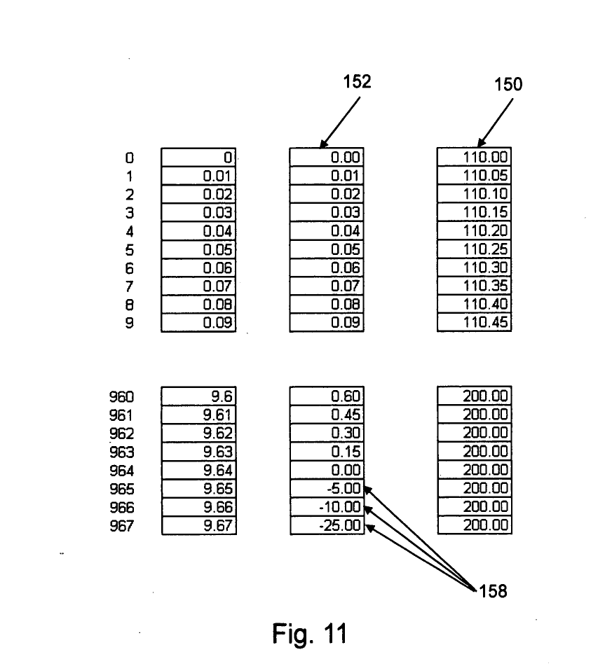

The user traces the skyline 112x by moving the shade analysis device 23 at a typical rate of between ten degree and twenty five degrees per second. Alternative sweep rates may also be used, so long as the sweep rate is sufficiently slow to accommodate readings by the accelerometer 2 and the electronic compass 4. The program 18 acquires readings, or samples, from the electronic compass 4 to establish an array 150 of azimuth heading samples and acquires readings, or samples, from the accelerometer 2 to establish an array 152 of corresponding elevation samples to provide a plot of the user-traced skyline 112x that includes the solar obstructions 122, 124, 126, 128 (shown in FIG. 12). Typically, the readings from the electronic compass 4 and accelerometer 2 are oversampled and passed through a low pass filter to remove high frequency noise. The resulting samples from the electronic compass 4 and accelerometer 2 are stored in the memory 16 in corresponding arrays 150 and 152, respectively, as shown in FIG. 11.

To end the user-tracing of the skyline 112x in an alternative example, the user may lower the elevation of the measurement edge 30 of the shade analysis device 23 quickly, for example, at a rate greater than 25 degrees of elevation per second, or the user may lower the elevation of the measurement edge 30 below a negative threshold value, such as negative 20 degrees (i.e. 20 degrees below the horizontal plane that is orthogonal to the Earth's gravity vector 46). The program 18 detects this abrupt lowering of the shade analysis device 23 or the negative elevation as an indication of the end of the user tracing of the skyline 112x, and removes the corresponding samples from the arrays 150, 152 that are acquired after the end of the sweep, indicated as elements 158 in FIG. 11. Once the skyline 112x is traced by the user, the program 18 typically automatically begins filtering, analyzing, or otherwise processing the resulting samples in the arrays 150, 152 to establish the elevations E and the azimuth headings H of the points that establish the skyline 112x. FIG. 12 shows an example of the user-traced skyline 112x superimposed on the sun plot 32 on the display 8.

The program 18 compares the azimuth heading (true bearing) and elevation (angle above level) of the sun at the location L at any given time, to the azimuth heading H and elevation E from the arrays 15, 152, respectively, to calculate the hours of direct sunlight and the hours of shade in any day, or any other suitable measure of shade analysis that represents any of a variety of solar effects at the location L. Alternatively, the program 18 computes this over a full year to determine shade factor, the percentage of direct sunlight lost due to the obstructions, and/or the amount of solar energy that could be captured by a solar panel at that location L. The program 18 alternatively compiles the arrays and analysis results into .pdf or .csv files, or any other of a variety of formats such as for export to a separate computer system (not shown) via the communication port 20 of the shade analysis device 23. These results may also be assigned a name and stored in the memory 16 for later retrieval or for further analysis.

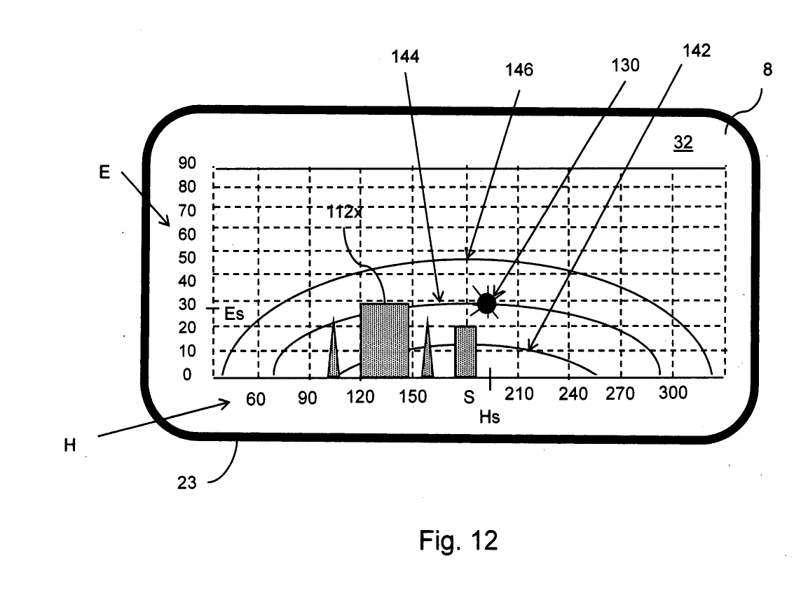

FIG. 13 shows an example of a “what-if” scenario, to determine the impact of removing a solar obstruction, such as the tree 122, from the user-traced skyline 112x. In this example, once the user has traced the skyline 112x, the program 18 enables a user to modify the skyline 112x represented by the samples acquired from a previous user-tracing of the skyline 112x. To modify the skyline 112x, the user repeats a tracing of a portion 112y of the skyline 112x, within a sub-range of azimuth headings of interest, namely a sub-range of azimuth headings that includes the tree 122 in this example. The program 18 then substitutes the samples in the arrays 152, 150, with the samples of the elevation and the samples of the azimuth heading from the skyline 112y. The program 18 then derives statistics on the resulting improvement in sunlight and energy at the location L. In a similar way the program 18 may combine samples of the elevation and samples of the azimuth heading from multiple short segments, or portions of the skyline 112x, for shade analysis. The program 18 also supports editing of the skyline 112x typically via the touch screen 9, keyboard 12 or other user interface of the shade analysis device 23. This also enables the user to edit out or add a solar obstruction to the skyline 112x, for example, simulating a tree being removed or a building being constructed. The program 18 can then compute the solar energy or shade differential based on the presence or absence of the solar obstruction. The program 18 is also enabled to support combining the measurements from multiple arrays 150, 152 in various ways. For example, the program 18 may average four arrays 150 and four arrays 152, taken at four corners of a solar array to provide an estimate of the average shade factor or solar energy delivered to the solar array.

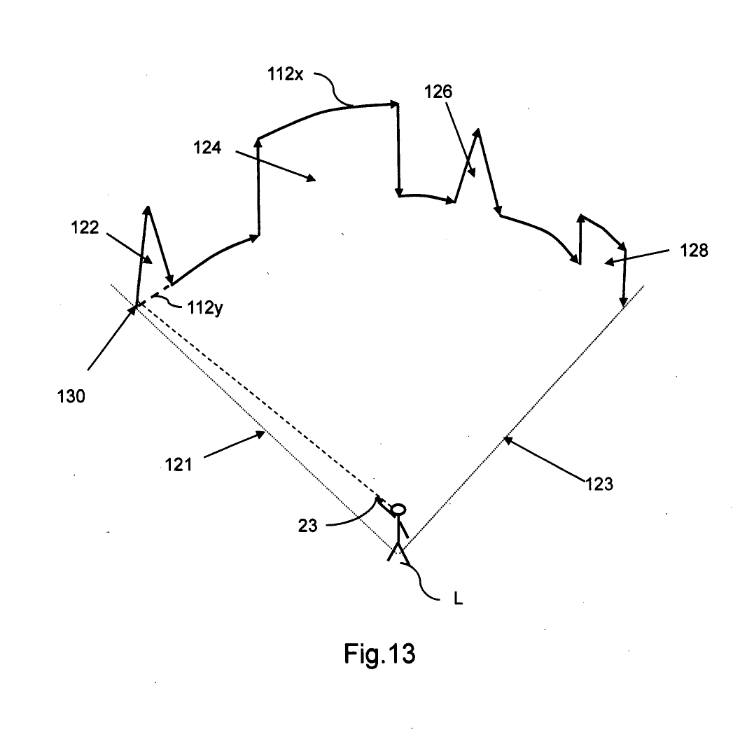

In an alternative example shown in FIG. 14, the skyline 112x is traced through sequential sighting of elevations and azimuth headings of positions 190-202 on the skyline 112x, using the measurement edge 30. In this example, the program 18 then constructs the skyline 112x in a piece-wise manner by connecting the sequentially sighted positions 190-202.

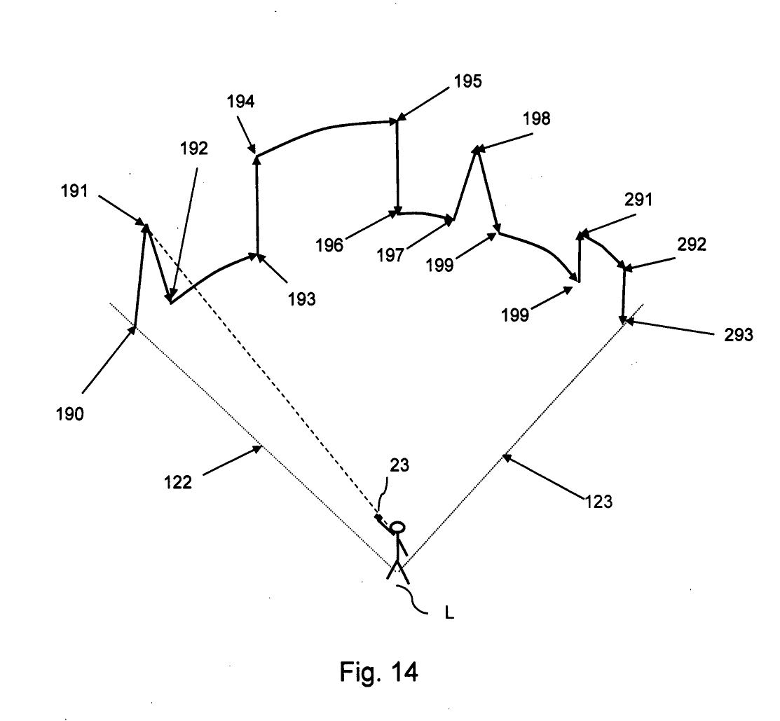

FIG. 15 shows a side view of the shade analysis device 23 of FIG. 1B, which includes the digital camera 1 according to alternative embodiments of the present invention. The digital camera 1 typically includes a lens and light sensitive array such as CCD (not shown), which provide a vertical field of view 40 as shown. The vertical field of view 40 is provided as an input to the program 18. A sighting line 42 represents an optical axis of the lens that runs from the center of the horizontal and vertical fields of view of the digital camera 1 to a point 100 on the solar obstruction, which in this example, is the building 124. The sighting line 42 typically projects at a right angle to the display 8 and to a plane that includes the digital camera 1 of the shade analysis device 23. The sighting point 100 centered within the vertical field of view 40 defines the elevation orientation of images that are captured by the digital camera 1 or otherwise shown on the display 8. By determining the tilt angle of the digital camera 1 using the accelerometer 2, the program 18 is enabled to calculate the elevation E of the sighting point 100 relative to the horizontal plane (0 degrees) established orthogonal to the Earth's gravity vector 46. In this example, the accelerometer 2 measures elevation E based on the orientation of the shade analysis device 23 using the ATAN2 function, wherein the arguments of the ATAN2 function include values in the direction X and the direction Z. From the elevation E and the known vertical field of view 40, the program 18 can determine the elevation of any point within the images that are captured by the digital camera 1 or that are otherwise shown on the display 8.

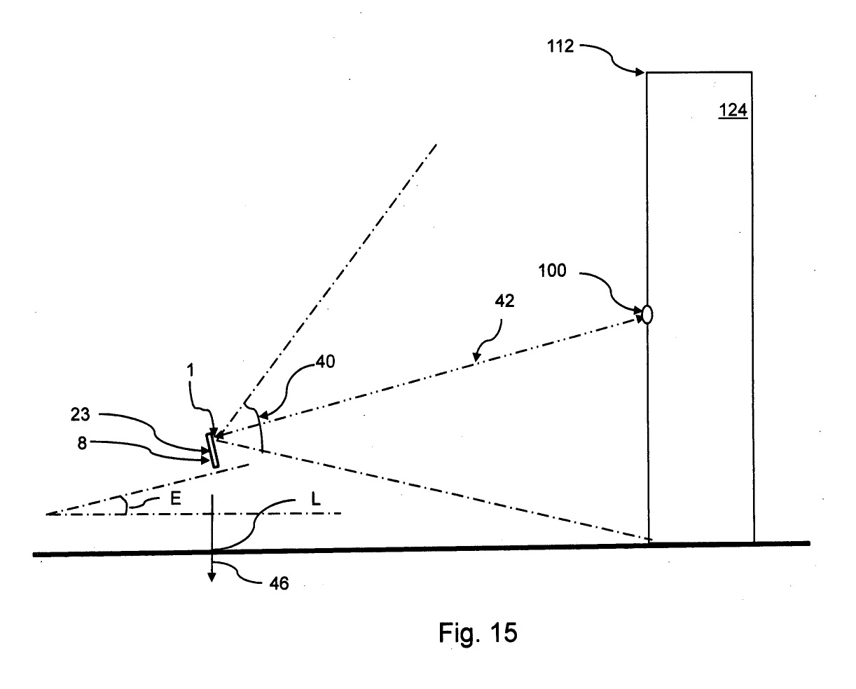

FIG. 16 shows a plan view of the shade analysis device 23 corresponding to the side view of FIG. 15. The digital camera 1 has a horizontal field of view 50, which is also input to the program 18. The sighting line 42 also runs from the center of the horizontal field of view 50 of the digital camera 1 and defines an azimuth heading H for images that are captured by the digital camera 1 or otherwise shown on the display 8. By determining the azimuth heading of the digital camera 1 using the electronic compass 4, the program 18 determines the azimuth heading H of a sighting point 100 relative to direction south is indicated by the arrow S (180 degrees). From the azimuth heading H and the known horizontal field of view 50, the program 18 determines the azimuth heading H at any point within the images that are captured by the digital camera 1 or otherwise shown on the display 8.

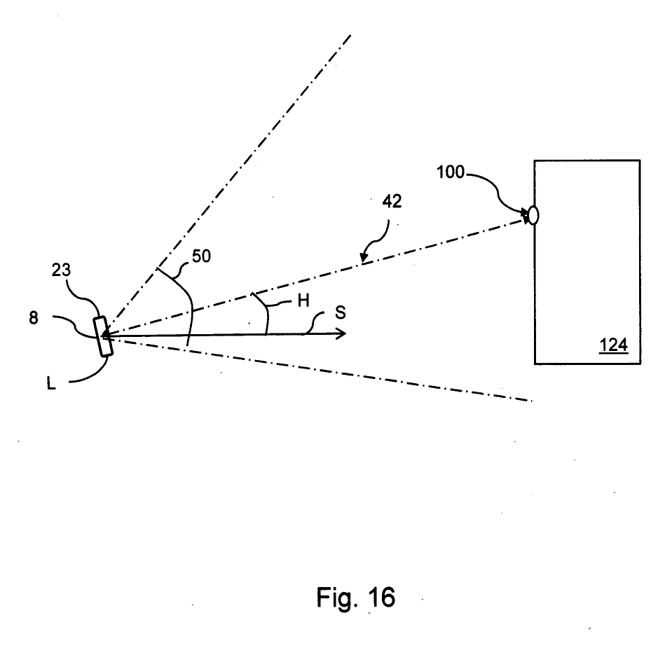

According to first alternative embodiments of the present invention, the shade analysis device 23 of FIG. 1B provides cross-hairs 33 on the display 8 of the digital camera 1 as a sighting reference (shown in FIG. 17). In this example, the array 150 of samples of azimuth headings and the array 152 of corresponding samples of elevation are acquired while a user moves the shade analysis device 23 so that the cross-hairs 33 trace the skyline 112x over a range of azimuth headings that includes the solar obstructions such as the trees 122, 126 and the buildings 124, 128. The user traces the skyline 112x by adjusting the tilt angle of shade analysis device 23 so that the cross-hairs 33, or other sighting reference provided on the display 8, are aimed at sighting points on the interface between the sky and the solar obstructions, which define the skyline 112x. In the side view of FIG. 15, the line 42 would be aimed at the sighting point 112 on the skyline 112x using the cross-hairs 33 on the display 8 to provide the elevation E at that sighting point 112. The skyline 112x that is traced by the user in this example may also be superimposed on the sun plot 32 shown in the example of FIG. 12.

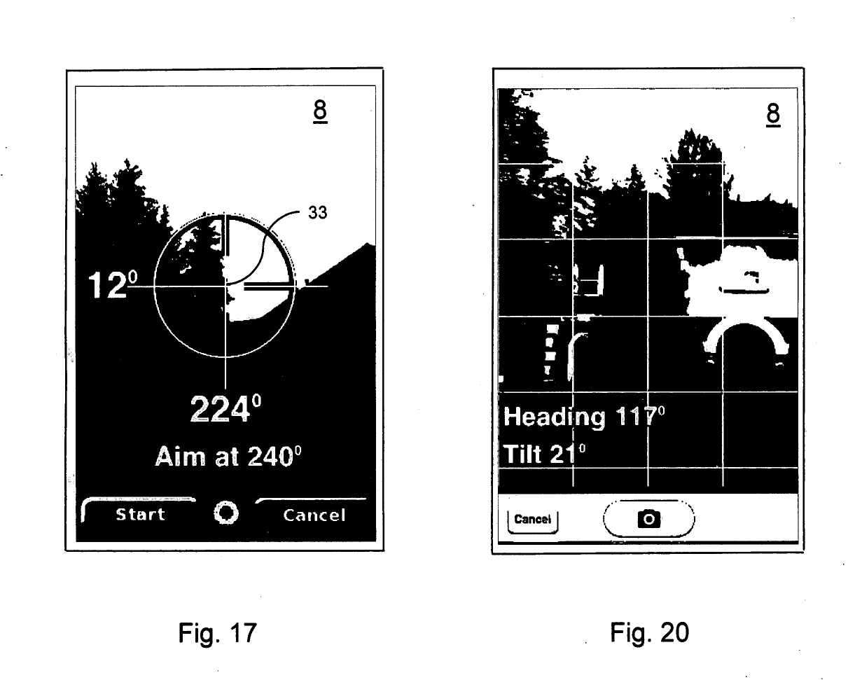

According to second alternative embodiments of the present invention, the shade analysis device 23 of FIG. 1B captures a series of images 102, 104, 106, 108, etc. that collectively include the skyline 112x. In this example, the user orientates the shade analysis device 23 with the digital camera 1 pointed at a starting point at an azimuth heading of approximately 30 degrees and aims at the point 100, as shown in FIG. 18. The program 18 records and stores the coordinates of the location L from the GPS receiver 5, or through user entry of the coordinates of the location L. The program 18 indicates to the user to start the capture of the images 102, 104, 106, 108, etc. with an audible signal from the sound generator 6. The program 18 acquires a first image 102, which is stored in the memory 16 along with the azimuth heading provided by the electronic compass 4, the tilt angle provided by the accelerometer 2 and the time that the image 102 was acquired, provide by the system clock 22. The user scans the horizon that contains the skyline 112x at a sufficiently slow rate, such as ten degree per second. The program 18 periodically acquires the samples of the azimuth heading and the tilt angle, or elevation, and stores the samples in the memory 16. When the shade analysis device 23 detects that the user has swept over an azimuth heading range that is approximately 80% of the horizontal field of view 50 of the digital camera 1, the program 18 triggers acquisition of a next image 104 and stores it along with the first image 102 in the memory 16. The program 18 continues this image acquisition process with the sampling of the corresponding azimuth headings and tilt angles, as the user sweeps, or pans, the shade analysis device 23 across the range of azimuth headings. When the user stops moving the shade analysis device 23, the program 18 acquires a final image in the series of images 102, 104, 106, 108, etc., and begins analysis of the acquired images 102, 104, 106, 108, etc. The program 18 then analyzes the elevations E and azimuth headings H of the points that define the skyline 112x within the acquired images 102, 104, 106, 108, etc.

FIG. 18 shows a perspective view of a sweep of the skyline 112x via the capture of the images 102, 104, 106, 108, etc. that collectively include the solar obstructions 122, 124, 126, 128. In this example, the location L is in the Northern hemisphere. Accordingly, a user of the shade analysis device 23 captures the images 102, 104, 106, 108, etc. that include the skyline 112x, with the line 42 projecting in a southerly direction and being swept, or panned, from the East (left) towards West (right). The digital data representing the captured images 102, 104, 106, 108, etc. are stored in image files in the memory 16 and are associated with the arrays 150, 152.

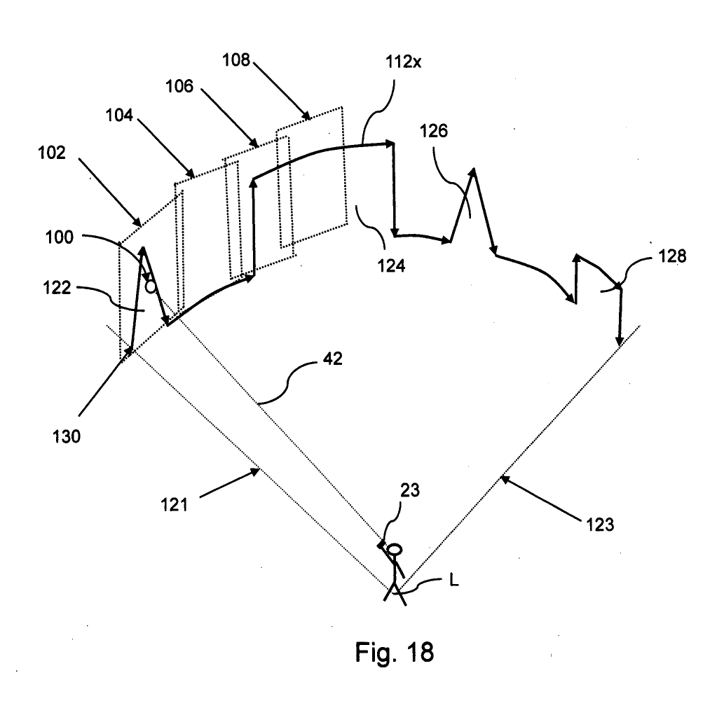

FIG. 19 shows an example combination of the multiple captured, or acquired images 102, 104, 106, 108, etc. The image resolution is input to the program 18 or the image resolution is derived automatically by reading the size of the image files that correspond to the images 102, 104, 106, 108, etc. To process the acquired images to derive the skyline 112x defined by the solar obstructions 122, 124, 126, 128, the program 18 uses the first image 102 together with the tilt angle, or elevation, and the azimuth heading associated with the first image 102. Knowing the horizontal field of view 50 and the vertical field of view 40 of the digital camera 1, the program 18 determines that the first pixel on the left hand side of the image 102 is at an azimuth heading that is equal to the azimuth heading value provided by the electronic compass 4 when the image was acquired, minus half of the horizontal field of view 50. Similarly, the top-most pixel in the image 102 is at an elevation equal to the tilt angle provided by the accelerometer 2 when the image was acquired, plus half of the vertical field of view of the digital camera 1. In this fashion, based on the vertical field of view 40, the horizontal field of view 50, and the number of pixels in the vertical and horizontal directions of the acquired images 102, 104, 106, 108, etc., the degrees of elevation and azimuth heading per each pixel in the acquired images are readily determined. Therefore, by detecting which pixels in each of the images 102, 104, 106, 108, etc. depict the skyline 112x, the elevation E and azimuth heading H for each of the points on the skyline 112x are determined. Detecting which pixels depict the skyline 112x is performed using any of a variety of known skyline detection techniques.

An example illustrates a skyline detection technique where the digital camera 1 has a horizontal field of view 50 equal to 50 degrees, a vertical field of view 40 equal to 100 degrees, with the first image 102 acquired at a heading of 85 degrees and a tilt angle of 30 degrees, and the image resolution is 100×200 pixels. Here, the left of the acquired image 102 has a heading of 60 degrees, and each pixel in a horizontal direction to the right corresponds to a half of a degree of azimuth heading. Similarly, the top of the image 102 is at an elevation of 80 degrees and each pixel in a vertical direction corresponds to a half of a degree of elevation. The program 18 then performs pixel analysis starting at the top of each pixel column and detecting the interface between the open sky or cloud colors, and the solar obstructions 122, 124, 126, 128, that form the skyline 112x. The elevation E and the azimuth heading H at each point detected within the skyline 112x is typically stored in a results array. This skyline detection process is repeated until the last column within the image 102 is processed, which in this example corresponds to an azimuth heading of 110 degrees. Then, the second image 104 is processed in a similar fashion to the first, the difference being that the starting point for the pixel analysis is 110 degrees, which corresponds to an azimuth heading where the first image 102 is finished. Hence, the program 18 finds the reference point 100 within the second image 104 and moves to the left to the column that represents 110.5 degrees. This pixel analysis is performed on the columns of the second image 104, with the points on the skyline 112x within the image 104 being appended to the entries in the results array. This pixel analysis process is repeated for each of the acquired images until all of the images 102, 104, 106, 108, etc. have been processed. This results in the results array holding a representation of the skyline 112x at increments of a degree of azimuth heading. This information may be saved in the memory 16 with a distinct file name for subsequent recall.

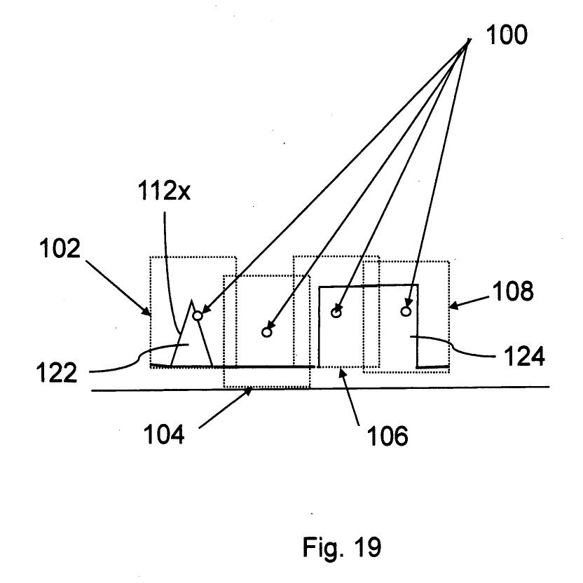

Pixel analysis is alternatively implemented with binary search algorithms or any other search methods. The series of images 102, 104, 106, 108, etc. may also be stitched together using commonly available panorama stitching tool prior to analysis. FIG. 20 shows an example of an image acquired by the digital camera 1 with overlaid grid lines having azimuth headings and elevations indicated by line spacings of ten degrees.

While the embodiments of the present invention show the shade analysis device at locations L that are in the Northern hemisphere, wherein the sighting references are typically aimed in the southerly direction, the program 18 alternatively accommodates for locations L that are in the Southern hemisphere, wherein the sighting references are typically aimed in the northerly direction.

While the embodiments of the present invention have been illustrated in detail, it should be apparent that modifications and adaptations to these embodiments may occur to one skilled in the art without departing from the scope of the present invention as set forth in the following claims.

1. A shade analysis device, comprising:
an accelerometer providing samples that represent an elevation defined by a sighting reference;
an electronic compass providing samples that represent an azimuth heading defined by the sighting reference; and
a processor, under the control of a program included in the shade analysis device, acquiring an array of the samples that represent the azimuth heading and an array of corresponding samples that represent the elevation, in response to tracing with the sighting reference, a skyline at an interface between an open sky and at least one solar obstruction over a range of azimuth headings.

2. The shade analysis device of claim 1 wherein the sighting reference is provided by a measurement edge of shade analysis device, and wherein the tracing results from moving the shade analysis device to change the elevation defined by the sighting reference as the shade analysis device is swept over the range of azimuth headings.

3. The shade analysis device of claim 1 wherein the array of samples that represent the azimuth heading and the array of corresponding samples that represent the elevation are acquired while a user of the shade analysis device traces the sighting reference over the interface between the open sky and the at least one solar obstruction over the range of azimuth headings.

4. The shade analysis device of claim 1 wherein the program uses the array of samples that represent the azimuth heading and the array of corresponding samples that represent the elevation to superimpose a plot of the skyline on a sun plot.

5. The shade analysis device of claim 3 wherein the program is enabled to remove one or more solar obstructions of the at least one solar obstruction from the skyline and to provide a shade factor based on the removed one or more solar obstructions.

6. The shade analysis device of claim 3 wherein the program is enabled to provide a shade factor based on the array of samples that represent the azimuth heading and the array of corresponding samples that represent the elevation of the skyline.

7. The shade analysis device of claim 1 further comprising a digital camera that provides the sighting reference on a display.

8. The shade analysis device of claim 7 wherein the sighting reference includes a cross-hair on the display.

9. The shade analysis device of claim 7 wherein the array of samples that represent the azimuth heading and the array of corresponding samples that represent the elevation are acquired while a user of the shade analysis device traces the sighting reference over the interface between the open sky and the at least one solar obstruction over the range of azimuth headings.

10. The shade analysis device of claim 9 wherein the program uses the array of samples that represent the azimuth heading and the array of corresponding samples that represent the elevation to superimpose a plot of the skyline on a sun plot.

11. The shade analysis device of claim 9 wherein the digital camera acquires at least one image while the user traces the skyline at the interface between an open sky and the at least one solar obstruction.

12. The shade analysis device of claim 11 wherein the program is enabled to superimpose the at least one image on a plot of the skyline at the interface between an open sky and the at least one solar obstruction.

13. A method of shade analysis, comprising:
providing samples that represent an elevation defined by a sighting reference;
providing samples that represent an azimuth heading defined by the sighting reference; and
acquiring an array of the samples that represent the azimuth heading and an array of corresponding samples that represent the elevation in response to tracing with the sighting reference over a range of azimuth headings, a skyline at an interface between an open sky and at least one solar obstruction.

14. The method of shade analysis of claim 13 wherein the sighting reference is provided by at least one of a measurement edge of a smartphone, and an icon on a display associated with a digital camera of the smartphone.

15. The method of shade analysis of claim 14 wherein the tracing results from moving the smartphone to change the elevation defined by the sighting reference as the smartphone is swept over the range of azimuth headings.

16. The shade analysis device of claim 13 further comprising receiving the array of samples that represent the azimuth heading and the array of corresponding samples that represent the elevation, and superimposing a plot of the skyline on a sun plot.

17. A shade analysis device, comprising:
a digital camera providing a sighting reference on a display;
an accelerometer providing representations of elevations established by aiming the sighting reference;
an electronic compass providing representations of azimuth headings established by the aiming of the sighting reference;
a memory storing an array of azimuth heading samples from the electronic compass and an array of corresponding elevation samples from the accelerometer, which depict a skyline traced over a range of azimuth headings that results from aiming the sighting reference at an interface between an open sky and at least one solar obstruction; and
a processor enabled by a program to provide a plot of at least one of the skyline, a sun plot and one or more images acquired by the digital camera as the sighting reference is aimed at the interface between the open sky and the at least one solar obstruction.

18. The shade analysis device of claim 17 further comprising a GPS receiver providing location information of the shade analysis device to the processor that uses the location information to provide a sun plot.

19. The shade analysis device of claim 18 wherein one or more of the digital camera, the accelerometer, the electronic compass, the memory, the processor, the program, and the GPS receiver are included within a smartphone.

20. The shade analysis device of claim 17 wherein the program is enabled to stitch one or more images acquired by the digital camera to form a panorama of a horizon that includes the interface between the open sky and the at least one solar obstruction.
